(19) United States
(12) Patent Application Publication
(10) Pub. No.: US 2009/0288771 A1
(43) Pub. Date: Nov. 26, 2009

(54) SURFACE-PROMOTED CURE OF ONE-PART RADICALLY CURABLE COMPOSITIONS

(75) Inventors: David Farrell, Kingswood (IE); Ciaran B. McArdle, Dublin (IE); Michael Doherty, Donegal (IE)

Correspondence Address: Loctite Corporation, One Henkel Way, Rocky Hill, CT, 06067, US

(73) Assignee: Loctite (R&D) Limited, Dublin (IE)

(21) Appl. No.: 12/470,911

(22) Filed: May 22, 2009

Related U.S. Application Data
(60) Provisional application No. 61/055,534, filed on May 23, 2008.

(51) Int. Cl. B32B 37/12; C08F 8/04; C08F 8/06

(52) U.S. Cl. 156/332; 525/371; 525/370

(57) ABSTRACT

The present invention relates to radically curable compositions for curing on a surface comprising a radically curable component, and an initiator component capable of initiating cure of the radically curable component. The initiator comprises at least one metal salt and a free radical generating component. The metal salt of the composition is chosen so that it is reduced at the surface, where the standard reduction potential of the metal salt is greater than the standard reduction potential of the surface, and where when the composition is placed in contact with the surface, the metal salt is reduced at the surface, and interacts with the free radical generating component, thereby initiating cure of the radically curable component of the composition. No catalytic component is required in the composition for efficient curing.

### FIELD OF THE INVENTION

The present invention relates to stable one-part radically curable compositions for curing on a surface.

### DISCUSSION OF BACKGROUND ART

### Reduction-Oxidation (RedOx) Radical Polymerisation:

RedOx polymerizations involve oxidation and reduction processes [Holtzclaw, H. F.; Robinson, W. R.; Odom, J. D.; General Chemistry, 1991, 9^{th} Ed., Heath (Pub.), p. 44]. When an atom, either free or in a molecule or ion, loses an electron or electrons, it is oxidised and its oxidation number increases. When an atom, either free or in a molecule or ion, gains an electron or electrons, it is reduced and its oxidation number decreases. Oxidation and reduction always occur simultaneously, as if one atom gains electrons then another atom must provide the electrons and be oxidised. In a RedOx couple, one species acts as a reducing agent, the other as an oxidizing agent. When a RedOx reaction occurs the reducing agent gives up or donates electrons to another reactant, which it causes to be reduced. Therefore the reducing agent is itself oxidised because it has lost electrons. The oxidising agent accepts or gains electrons and causes the reducing agent to be oxidised while it is itself reduced. A comparison of the relative oxidising or reducing strengths of strength of the two reagents in a redox couple permits determination of which one is the reducing agent and which one is the oxidising agent. The strength of reducing or oxidising agents can be determined from their standard reduction (E_{red}⁰) or oxidation (Eₒₓ⁰) potentials.

Redox radical polymerisation, for example in the field of anaerobic acrylate adhesive formulations is an established adhesives technology (U.S. Pat. Nos. 2,628,178; 2,895,950; 3,218,305; and 3,435,012). Anaerobic adhesive formulations are used in a wide range of industrial applications including thread-locking, flange sealing, structural bonding, and engine block sealing amongst others (Haviland, G. S.; Machinery Adhesives for Locking Retaining & Sealing, Marcel Dekker (Pubs.), New York, 1986).

Anaerobic adhesive systems are typically composed of a radically susceptible monomer, an oxidising agent and a reducing agent [Rich, R.; Handbook of Adhesive Technology ed. Pizzi, A. & Mittal, K. L., Marcel Dekker (Pubs.), 1994, Chap. 29, 467-479]. Typical oxidising agents are hydroperoxides of which cumene hydroperoxide (“CHP”) is most commonly employed although others including t-butyl hydroperoxide (“BHP”) are also used. In general the reducing agents consist of a mixture of an amine such as dimethyl-p-toluidine (“DMPT”) and saccharin (Moane, S. et al.; Int. J. Adh. & Adh, 1999, 19, 49-57), or acetylphenylhydrazine (“APH”) [Rich, R.; Handbook of Adhesive Technology ed. Pizzi, A. & Mittal, K. L., Marcel Dekker (Pubs.), 1994, Chap. 29, 467-479].

Known Incompatibility of Hydroperoxides with Transition Metal Salts:

Hydroperoxides can function as oxidants, reductants or even both (Kharash, M. S. et al.; J. Org. Chem., 1952, 17, 207-220). Several mechanisms for the oxidising action of a hydroperoxide include abstraction of a single electron, abstraction of a pair of electrons from an electron donor or through the donation of an oxygen atom to an acceptor (Kharash, M. S. et al.; J. Org. Chem., 1952, 17, 207-220).

Hydroperoxides are known to be unstable in the presence of metallic salts in both their lower and higher oxidation states. It is this instability that is understood to contribute to their reactivity when used as the initiating component in anaerobic acrylate adhesives. Scheme 1 shows oxidative and reductive hydroperoxide decomposition by transition metal species in their higher and lower oxidation states.

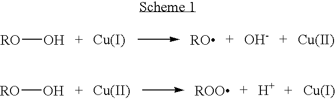

There is thus still an unsatisfied need for suitable hydroperoxide compatible radically curable formulations which provide alternatives to the amine/organic reducing agent formulations set out above. Furthermore, there is a need for one part radically curable compositions that will exhibit long-term stability and will only cure upon application to a target surface.

### SUMMARY OF THE INVENTION

In one embodiment, the present invention provides for a stable one-part radically curable composition for curing on a surface comprising:

i) a radically curable component;

ii) a free radical generating component; and

iii) at least one metal salt;

where the standard reduction potential of the at least one metal salt is greater than the standard reduction potential of the surface, and

where when the composition is placed in contact with the surface, the metal salt is reduced at the surface, and interacts with the free radical generating component, thereby initiating cure of the radically curable component of the composition.

References to standard reduction potentials in this specification indicate the tendency of a species to acquire electrons and thereby be reduced. Standard reduction potentials are measured under standard conditions: 25° C., 1 M concentration, a pressure of 1 atm and elements in their pure state.

Desirably the metal salt of the composition comprises a transition metal cation. Suitable metals include copper, iron, zinc and combinations thereof. The metal salt may be substituted with a ligand. Desirably, the metal salt counterion may be chosen from naphthenate, ethylhexanoate, benzoate, nitrate, chloride, acetylacetonate, ClO₄⁻, BF₄⁻, PF₆⁻, SbF₆⁻, AsF₆⁻, (C₆F₅)₄B, (C₆F₅)₄Ga, Carborane, triflimide, bis-triflimide, anions based thereon and combinations thereof. Further desirably the metal salt counterion may be chosen from naphthenate, ethylhexanoate, benzoate, nitrate, chloride, acetylacetonate, ClO₄⁻, BF₄⁻, PF₈⁻, SbF₆⁻ and combinations thereof. Preferably, the metal salt counterion may be chosen from ClO₄⁻, BF₄⁻ and combinations thereof.

The solubility of the metal salt may be modified by changing the counterion, the addition and/or substitution of ligands to the metal of the metal salt and combinations thereof. This will allow for efficient electron transfer between the surface and the metal salt to be observed as appropriate solubility is achieved.

The radical generating component may be selected from peroxides, hydroperoxides, hydroperoxide precursors, persulfates and combinations thereof. Suitable materials comprise cumene hydroperoxide, tert-butyl hydroperoxide, hydrogen peroxide, 2-butanone peroxide, di-tert-butyl peroxide, dicumyl peroxide, lauroyl peroxide, 2,4-pentanedione peroxide, pentamethyl-trioxepane [such as that sold under the trade name Trigonox® 311], benzoyl peroxide and combinations thereof.

The radically curable component desirably has at least one functional group selected from acrylates, methacrylates, thiolenes, siloxanes, vinyls with combinations thereof also being embraced by the present invention. Preferably, the radically curable component has at least one functional group selected from acrylates, methacrylates, thiolenes and combinations thereof.

Desirably, the surfaces to which the compositions of the present invention are applied may comprise a metal, metal oxide or metal alloy. Further desirably, the surface may comprise a metal or metal oxide. Preferably, the surface may comprise a metal. Suitable surfaces can be selected from iron, steel, mild steel, grit blasted mild steel, aluminium, aluminium oxide, copper, zinc, zinc oxide, zinc bichromate, and stainless steel. References to aluminium and aluminium oxide include alclad aluminium (low copper content), and oxide removed alclad aluminium (low copper content) respectively. Desirably, the surface can be selected from steel and aluminium. Metal salts suitable for use in compositions for curing on steel or aluminium surfaces may be chosen from iron salts, copper salts, zinc salts and combinations thereof, and where the counterions of the iron, copper and zinc salts may be chosen from naphthenate, ethylhexanoate, benzoate, nitrate, chloride, acetylacetonate, ClO₄⁻, BF₄⁻ and combinations thereof.

In general, the inventive compositions disclosed herein can cure on oxidised metal surfaces without the need for additional etchant or oxide remover. However, the compositions of the invention may optionally include an oxide remover. For example, including an etchant or oxide remover, such as those comprising chloride ions and/or a zinc (II) salt, in formulations of the invention allows etching of any oxide layer. This will in turn expose the (zero-oxidation state) metal below, which is then sufficiently active to allow reduction of the transition metal salt.

The RedOx radically curable coating compositions discussed herein do not require any additional reducing agent. They are stable until contacted with a metallic substrate which is capable of participating in a RedOx reaction (or other surface capable of participating in a RedOx reaction), thus fulfilling the role of a conventional reducing agent component. The radically curable compositions of the invention are storage stable as a one-part composition when stored in air permeable containers. The stability of large volumes of the radically curable coating compositions of the present invention can be improved by continuous agitation and/or bubbling air through the composition.

The compositions of the present invention do not require an additional catalyst for efficient curing. The present invention utilises appropriate selection of the initiator component relative to the surface on which the composition is to be applied and cured. Thus surface promoted RedOx chemistry can be utilised to initiate cure in radically curable compositions. However, it will be appreciated that compositions according to the invention may optionally comprise a catalyst to affect electron transfer between the surface and the metal salt of the composition. This may be useful where even greater cure speeds are required. Suitable catalysts include transition metal salts.

The inventive compositions will generally be useful as adhesives, sealants or coatings, and can be used in a wide range of industrial applications including metal bonding, thread-locking, flange sealing, and structural bonding amongst others.

The inventive compositions may be encapsulated, if it is desirable to do so. Suitable encapsulation techniques comprise, but are not limited to, coacervation, softgel and co-extrusion.

Alternatively, the inventive compositions may be used in a pre-applied format. It will be appreciated that the term pre-applied is to be construed as taking the material in an encapsulated form (typically but not necessarily micro-encapsulated) and dispersing said capsules in a liquid binder system that can be dried (e.g. thermal removal of water or an organic solvent, or by photo-curing the binder) on the desired substrate. A film of material remains which contains the curable composition (for example adhesive liquid for example in the form of filled capsules). The curable composition can be released for cure by physically rupturing the material (for example capsules) when the user wishes to activate the composition, e.g. in pre-applied threadlocking adhesives the coated screw threaded part is activated by screwing together with its reciprocally threaded part for example a threaded receiver or nut.

In a further embodiment the invention extends to an initiator package for initiating cure of a radically curable component comprising:
i) a free radical generating component; and
ii) at least one metal salt.

The metal salt counterion may be chosen from naphthenate, ethylhexanoate, benzoate, nitrate, chloride, acetylacetonate, ClO₄⁻, BF₄⁻, PF₆⁻, SbF₆⁻, AsF₆⁻, (C₆F₅)₄B, (C₆F₅)₄Ga, Carborane, triflimide, bis-triflimide, anions based thereon and combinations thereof. Further desirably the metal salt counterion may be chosen from naphthenate, ethylhexanoate, benzoate, nitrate, chloride, acetylacetonate, ClO₄⁻, BF₄⁻, PF₆⁻, SbF₆⁻ and combinations thereof. Preferably, the metal salt counterion may be chosen from ClO₄⁻, BF₄⁻ and combinations thereof.

The invention further extends to a process for bonding two substrates together comprising the steps of:
(i) applying a composition comprising:
   i) a radically curable component;
   ii) a free radical generating component; and
   iii) at least one metal salt;

to at least one of the substrates; and
(ii) mating the first and second substrates so as to form a bond with the composition,

where the standard reduction potential of the at least one metal salt is greater than the standard reduction potential of at least one of the substrates.

In one particular embodiment, both substrates comprise a metal. Where the second substrate comprises a different metal substrate to the first metal substrate the composition of the invention may comprise more than one type of metal salt. Thus, the invention also provides for curable compositions wherein the inclusion of more than one type of metal salt in the composition allows the composition to bond different metal substrates together.

Desirably, the metal of the metal salt of the inventive compositions is lower in the reactivity series than the metal surface on which it is to be cured.

Metallic substrates can also be bonded to non-metallic substrates. For instance mild steel may be bonded to e-coated steel (e-coat is an organic paint which is electrodeposited, with an electrical current, to a metallic surface, such as steel).

Moreover, the inventive compositions of the present invention can be utilised to form (polymer) coatings on parts such as metallic parts.

The invention further relates to a pack comprising:

a) a container; and

b) a radically curable composition according to the present invention, where the container is air permeable.

### DETAILED DESCRIPTION OF THE INVENTION

The electrochemical series is a measure of the oxidising and reducing power of a substance based on its standard potential. The standard potential of a substance is measure relative to the hydrogen electrode. A metal with a negative standard potential has a thermodynamic tendency to reduce hydrogen ions in solution, whereas the ions of a metal with a positive standard potential have a tendency to be reduced by hydrogen gas. The reactivity series, shown in Scheme 2 (above), is an extension of the electrochemical series. Ordinarily, only a metal or element positioned higher in the reactivity series can reduce another metal or element that is lower down in the reactivity series e.g. iron can reduce tin but not potassium.

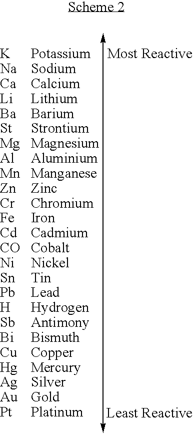

It is appreciated that the order of the reactivity series can be (changed) inverted from that shown in Scheme 2. The terms “higher” and “lower” will be understood however as referring to a reactivity series having at the most reactive at the top and the least reactive at the bottom. In any event in the context of the present invention it will be appreciated that the metal of the metal salt is chosen so that it is reducible at the surface to which it is applied.

### EXAMPLES

### General Procedure for Preparation of Adhesive Formulations:

To monomer (10 g) was added a quantity of metal salt and peroxide initiator. The salt and peroxide were thoroughly dissolved in the monomer by continuous stirring at room temperature. All samples were kept covered to exclude light during preparation and while in storage. Unless otherwise stated all metallic salts were used as received in their hydrated form. All “mmol” values given for metallic salts are calculated on an anhydrous basis. Where peroxides utilised mixed with a diluent, all calculations were based upon the actual concentration of peroxide required to achieve molar equivalence.

### General Procedure for Testing Formulations:

A standard test method was followed for testing all adhesive formulations based on ASTM E177 and ASTM E6.

### Apparatus

Tension testing machine, equipped with a suitable load cell.

### Test Specimens

Lap-shear specimens, as specified in the quality specification, product or test program.

### Assembly Procedure

1. Five test specimens were used for each test.
2. Specimen surface was prepared where necessary, i.e. mild steel lap-shears are grit blasted with silicon carbide.
3. Test specimens were cleaned by wiping with acetone or isopropanol before assembly.
4. Bond area on each lap-shear was 322.6 mm² or 0.5 in². This is marked before applying the adhesive sample.
5. A sufficient quantity of adhesive was applied to the prepared surface of one lap-shear.
6. A second lap-shear was placed onto the adhesive and the assembly was clamped on each side of the bond area.

### Test Procedure

After allowing for cure as specified in test program the shear strength was determined as follows:
   1. The test specimen was placed in the grips of the testing machine so that the outer 25.4 mm (1 in.) of each end were grasped be the jaws. The long axis of the test specimen coincided with the direction of applied tensile force through the centre line of the grip assembly.
   2. The assembly was tested at a crosshead speed of 2.0 mm/min or 0.05 in./min., unless otherwise specified.
   3. The load at failure was recorded.
      The following information was recorded:
   1. Identification of the adhesive including name or number, and lot number.
   2. Identification of the test specimens used including substrate and dimensions.
   3. Surface preparation used to prepare the test specimens.
   4. Cure conditions (Typically ambient room temperature only, 20-25° C.).
   5. Test Conditions (Standard Temperature and Pressure i.e. Room temperature).
   6. Environmental conditioning, if any (None, all substrates to be bonded are freshly prepared before use).
   7. Number of specimens tested, if other than 5 (Typically an average of 5 results for each quoted result).
   8. Results for each specimen.
   9. Average shear strength for all replicates.
   10. Failure mode for each specimen when required by the quality specification, product profile, or test program.
   11. Any deviation from this method.

### Peroxide Component

### Example 1

Cu(BF₄)₂ (0.1 g, 0.42 mmol) and Dodecanoyl peroxide (0.33 g, 0.82 mmol) were dissolved in Triethylene Glycol Dimethacrylate (10 g, mol).
   Adhesive performance following 24 hr at 20° C. on:
      Grit Blasted Mild Steel Lapshears. 6.2 N/mm²

### Example 2

Cu(BF₄)₂ (0.1 g, 0.42 mmol) and Benzoyl Peroxide (0.2 g, 0.82 mmol) were dissolved in Triethylene Glycol Dimethacrylate (10 g, mol).
   Adhesive performance following 24 hr at 20° C. on:
      Grit Blasted Mild Steel Lapshears: 6.5 N/mm²

### Example 3

Cu(BF₄)₂ (0.1 g, 0.42 mmol) and 3,3,5,7,7-pentamethyl-1,2,4-trioxepane {Trigonox® 311} (0.14 g, 0.82 mmol) were dissolved in Triethylene Glycol Dimethacrylate (10 g, mol).
   Adhesive performance following 24 hr at 20° C. on:
      Grit Blasted Mild Steel Lapshears: 4.8 N/mm²

### Example 4

Cu(BF₄)₂ (0.1 g, 0.42 mmol) and Cumene Hydroperoxide (0.13 g, 0.82 mmol) were dissolved in Triethylene Glycol Dimethacrylate (10 g, mol).
   Adhesive performance following 24 hr at 20° C. on:
      Grit Blasted Mild Steel Lapshears: 6.0 N/mm²

### Example 5

Cu(BF₄)₂ (0.1 g, 0.42 mmol) and 2,4-Pentanedione Peroxide (0.1 g, 0.41 mmol) were dissolved in Triethylene Glycol Dimethacrylate (10 g, mol).
   Adhesive performance following 24 hr at 20° C. on:
      Grit Blasted Mild Steel Lapshears: 4.1 N/mm²

### Monomer Component

### Example 6

Cu(BF₄)₂ (0.1 g, 0.42 mmol) and Benzoyl Peroxide (0.2 g, 0.82 mmol) were dissolved in Butane diol dimethacrylate (10 g).
   Adhesive performance following 24 hr at 20° C. on:
      Grit Blasted Mild Steel Lapshears: 4.75 N/mm²

### Example 7

Cu(BF₄)₂ (0.1 g, 0.42 mmol) and Benzoyl Peroxide (0.2 g, 0.82 mmol) were dissolved in Hydroxy ethyl methacrylate (10 g, mol).
   Adhesive performance following 24 hr at 20° C. on:
      Grit Blasted Mild Steel Lapshears: 5.0 N/mm²

### Example 8

Cu(BF₄)₂ (0.1 g, 0.42 mmol) and Benzoyl Peroxide (0.2 g, 0.82 mmol) were dissolved in Hydroxy Propyl Methacrylate (10 g, mol).
   Adhesive performance following 24 hr at 20° C. on:
      Grit Blasted Mild Steel Lapshears: 5.0 N/mm²

### Metal Salt Concentration

### Example 9

Cu(BF₄)₂ (0.1 g, 0.42 mmol) and Benzoyl Peroxide (0.1 g, 0.41 mmol) were dissolved in Triethylene Glycol Dimethacrylate (10 g, mol).
   Adhesive performance following 0.5 minutes at 20° C. on:
      Mild Steel Pin & Collar: 8.5 N/mm²
   Adhesive performance following 5 minutes at 20° C. on:
      Mild Steel Pin & Collar: 10.0 N/mm²

### Example 10

Cu(BF₄)₂ (0.02 g, 0.084 mmol) and Benzoyl Peroxide (0.1 g, 0.41 mmol) were dissolved in Triethylene Glycol Dimethacrylate (10 g, mol).
   Adhesive performance following 0.5 minutes at 20° C. on:
      Mild Steel Pin & Collar: 5.8 N/mm²
   Adhesive performance following 5 minutes at 20° C. on:
      Mild Steel Pin & Collar: 10.0 N/mm²

### Example 11

Cu(BF₄)₂ (0.01 g, 0.042 mmol) and Benzoyl Peroxide (0.1 g, 0.41 mmol) were dissolved in Triethylene Glycol Dimethacrylate (10 g, mol).
   Adhesive performance following 0.5 minutes at 20° C. on:
      Mild Steel Pin & Collar: 9.0 N/mm²
   Adhesive performance following 5 minutes at 20° C. on:
      Mild Steel Pin & Collar: 2.5 N/mm²

### Metal Salt Component

### Example 12

Cu(ClO₄)₂ (0.08 g, mmol) and Benzoyl Peroxide (0.1 g, 0.41 mmol) were dissolved in Triethylene Glycol Dimethacrylate (10 g).
   Adhesive performance following 24 hr at 20° C. on:
      Grit Blasted Mild Steel Lapshears: 8 N/mm²

### Example 13

Cu(Naphthenate)₂ {8% in White Spirits} (0.08 g) and Benzoyl Peroxide (0.1 g, 0.41 mmol) were dissolved in Triethylene Glycol Dimethacrylate (10 g).
   Adhesive performance following 24 hr at 20° C. on:
      Grit Blasted Mild Steel Lapshears: 3.7 N/mm²

### Example 14

Cu(Ethylhexanoate)₂ (0.089, mmol) and Benzoyl Peroxide (0.1 g, 0.41 mmol) were dissolved in Triethylene Glycol Dimethacrylate (10 g).
Adhesive performance following 24 hr at 20° C. on:
   Grit Blasted Mild Steel Lapshears: 3.2 N/mm²

### Example 15

Cu(Benzoate)₂ (0.08 g, mmol) and Benzoyl Peroxide (0.1 g, 0.41 mmol) were dissolved in Triethylene Glycol Dimethacrylate (10 g).
   Adhesive performance following 24 hr at 20° C. on:
      Grit Blasted Mild Steel Lapshears: 5.7 N/mm²

### Example 16

Cu(NO₃)₂ (0.08 g, mmol) and Benzoyl Peroxide (0.1 g, 0.41 mmol) were dissolved in Triethylene Glycol Dimethacrylate (10 g).
   Adhesive performance following 72 hr at 20° C. on:
      Grit Blasted Mild Steel Lapshears: 2.0 N/mm²

### Example 17

CuCl₂ (0.08 g, mmol) and Benzoyl Peroxide (0.1 g, 0.41 mmol) were dissolved in Triethylene Glycol Dimethacrylate (10 g).
   Adhesive performance following 72 hr at 20° C. on:
      Grit Blasted Mild Steel Lapshears: 4.5 N/mm²

### Example 18

Cu(Acetylacetonate)₂ (0.08 g, mmol) and Benzoyl Peroxide (0.1 g, 0.41 mmol) were dissolved in Triethylene Glycol Dimethacrylate (10 g).
   Adhesive performance following 24 hr at 20° C. on:
      Grit Blasted Mild Steel Lapshears: 2.6 N/mm²

### Example 19

Fe(ClO₄)₃ (0.08 g, mmol) and Benzoyl Peroxide (0.1 g, 0.41 mmol) were dissolved in Triethylene Glycol Dimethacrylate (10 g).
   Adhesive performance following 24 hr at 20° C. on:
      Grit Blasted Mild Steel Lapshears: 7.0 N/mm²

### Example 20

Zn(ClO₄)₂ (0.08 g, mmol) and Benzoyl Peroxide (0.1 g, 0.41 mmol) were dissolved in Triethylene Glycol Dimethacrylate (10 g).
   Adhesive performance following 24 hr at 20° C. on:
      Grit Blasted Mild Steel Lapshears: 7.0 N/mm²

### Example 21

Zn(BF₄)₂ (0.2 g, mmol) and Benzoyl Peroxide (0.1 g, 0.41 mmol) were dissolved in Triethylene Glycol Dimethacrylate (10 g).
   Adhesive performance following 24 hr at 20° C. on:
      Grit Blasted Mild Steel Lapshears: 7.8 N/mm²

### Example 22

Cu(BF₄)₂ (0.2 g, mmol), Zn(BF₄)₂ (0.2 g, mmol) and Benzoyl Peroxide (0.1 g, 0.41 mmol) were dissolved in Triethylene Glycol Dimethacrylate (10 g).
   Adhesive performance following 24 hr at 20° C. on:
      Grit Blasted Mild Steel Lapshears: 7.8 N/mm²

### Example 23

Cu(BF₄)₂ (0.2 g, mmol), Zn(ClO₄)₃ (0.2 g, mmol) and Benzoyl Peroxide (0.1 g, 0.41 mmol) were dissolved in Triethylene Glycol Dimethacrylate (10 g).
   Adhesive performance following 24 hr at 20° C. on:
      Grit Blasted Mild Steel Lapshears: 5.5 N/mm²

### Example 24

Fe(ClO₄)₃ (0.2 g, mmol), Zn(BF₄)₂ (0.2 g, mmol) and Benzoyl Peroxide (0.1 g, 0.41 mmol) were dissolved in Triethylene Glycol Dimethacrylate (10 g).
   Adhesive performance following 24 hr at 20° C. on:
      Grit Blasted Mild Steel Lapshears: 6.4 N/mm²

### Example 25

Fe(ClO₄)₃ (0.2 g, mmol), Zn(ClO₄)₂ (0.2 g, mmol) and Benzoyl Peroxide (0.1 g, 0.41 mmol) were dissolved in Triethylene Glycol Dimethacrylate (10 g).
   Adhesive performance following 24 hr at 20° C. on:
      Grit Blasted Mild Steel Lapshears: 6.5 N/mm²

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A radically curable composition for curing on a surface comprising:
i) a radically curable component;
ii) a free radical generating component; and
iii) at least one metal salt;
wherein the standard reduction potential of the at least one metal salt is greater than the standard reduction potential of the surface, and
wherein when the composition is placed in contact with the surface, the metal salt is reduced at the surface, and interacts with the free radical generating component, thereby initiating cure of the radically curable component of the composition.

2. A curable composition according to claim 1, wherein the at least one metal salt comprises a transition metal cation.

3. A curable composition according to claim 2, wherein the transition metal cation is selected from copper, iron, zinc and combinations thereof.

4. A curable composition according to claim 2, wherein the metal salt includes a counterion chosen from the group consisting of naphthenate, ethylhexanoate, benzoate, nitrate, chloride, acetylacetonate, ClO₄⁻, BF₄⁻, PF₆⁻, SbF₆⁻, AsF₆⁻, (C₆F₅)₄B, (C₆F₅)₄Ga, Carborane, triflimide, bis-triflimide, and combinations thereof.

5. A curable composition according to claim 1, wherein the radical initiating component is selected from the group consisting of peroxides, hydroperoxides, hydroperoxide precursors, persulfates and combinations thereof.

6. A curable composition according to claim 1, wherein the radical initiating component is selected from the group consisting of Cumene Hydroperoxide, tert-Butyl hydroperoxide, Hydrogen peroxide, 2-Butanone peroxide, Di-tert-Butyl peroxide, Dicumyl peroxide, Lauroyl peroxide, 2,4-Pentanedione peroxide, pentamethyl-trioxepane, Benzoyl Peroxide and combinations thereof.

7. A curable composition according to claim 1, wherein the radically curable component has at least one functional group selected from the group consisting of acrylates, methacrylates, thiolene, siloxanes, vinyls and combinations thereof.

8. A curable composition according to claim 1, wherein the surface comprises a metal, metal oxide or metal alloy.

9. A curable composition according to claim 1, wherein the surface is selected from the group consisting of iron, steel, mild steel, gritblasted mild steel, aluminium, aluminium oxide, copper, zinc, zinc oxide, zinc bichromate, and stainless steel.

10. A curable composition according to claim 1 further comprising a metal oxide removal agent.

11. A curable composition according to claim 1, wherein the metal oxide removal agent is selected from the group consisting of chloride ions, zinc (II) salts and combinations thereof.

12. A curable composition according to claim 1 further comprising a catalyst to effect electron transfer between the surface and the metal salt.

13. A curable composition according to claim 1 for adhering a first metallic substrate to another substrate.

14. A curable composition according to claim 1 for sealing.

15. (canceled)

16. An initiator package for initiating cure of a radically curable component comprising:
i) a free radical generating component; and
ii) at least one metal salt.

17. An initiator package according to claim 16, wherein the metal salt counterions are selected from the group consisting of naphthenate, ethylhexanoate, benzoate, nitrate, chloride, acetylacetonate, ClO₄⁻, BF₄⁻, PF₆⁻, SbF₆⁻, AsF₆⁻, (C₆F₅)₄B, (C₆F₅)₄Ga, carborane, triflimide, bis-triflimide, and combinations thereof.

18. A process for bonding two substrates together comprising the steps of:
(i) applying a composition comprising:
i) a radically curable component;
ii) a free radical generating component; and
iii) at least one metal salt;
to at least one of the substrates; and
(ii) mating the first and second substrates so as to form a bond with the composition,
where the standard reduction potential of the at least one metal salt is greater than the standard reduction potential of at least one of the substrates.

19. A process according to claim 18 wherein at least one substrate comprises a metal, metal oxide or metal alloy.

20. A process according to claim 19 wherein at least one substrate comprises a metal.

21. A pack comprising:
a) a container; and
b) a radically curable composition according to claim 1.

22. (canceled)
